(19) United States
(12) Patent Application Publication
(10) Pub. No.: US 2005/0165652 A1
(43) Pub. Date: Jul. 28, 2005

(54) Method of selling jewelry

(76) Inventor: John Ravenstein, Jackson, MS (US)

Correspondence Address: Stephen E. Feldman, P.C., 12 East 41st Street, New York, NY, 10017, US

(21) Appl. No.: 10/763,996

(22) Filed: Jan. 23, 2004

(51) Int. Cl. G06F 17/60

(52) U.S. Cl. 705/26

(57) ABSTRACT

A method for sell jewelry is provided including defining a collection of jewelry having a specific style and types of jewelry. A first advertising theme is developed that is in consonance with the style and types of pieces of jewelry. In addition, the advertising theme is constructed to tie the style and types of jewelry with a heritage of a target population of a geographically definable region. The collection of jewelry includes a plurality of selections of jewelry defining pieces of jewelry having a second theme of advertising. The second theme of advertising ties the selection of jewelry with sites defined in the region. The individual pieces of jewelry can be tailored from a range of being purchased as completed pieces or the pieces can be tailored to suit the needs of individual buyers.

### BACKGROUND

1. Technical Field

The present disclosure relates to methods for selling jewelry. More particularly, the present disclosure relates to methods for selling styles of jewelry using an advertising theme related to the styles of jewelry.

2. Background of Related Art

The selling of items is enhanced by novel methods of advertising systems. Novel advertising systems and methods include creative new methods or new ideas with existing ideas to create consumer appeal for specific types of products. The appeal to consumers of a product can be enhanced by the use of new technologies, humor, and themes that create a link or identification between the consumer andthe product.

In U.S. Pat. No. 6,421,986 B1 to Dharssi, a method of distributing advertising material within packages of bread is described. The disclosure includes defining packets containing one or more items from a range of categories of materials, such as coupons, health tips, product samples, and door magnets. The packets have the potential to further planned sales goals for specific items of local food selling chains, for example, and can also provide feedback on consumer habits. Dharssi, however, is limited in the scope of his invention by providing a vehicle for advertising and not defining any one specific advantageous theme of advertising that directly promotes the bread product by causing an identification of the bread product with a defined geographic target population.

In U.S. Pat. No. 6,404,519 to McAbee, a method for advertising on motor vehicles is described. The method includes using holographic film to project a holographic image onto a window of a race car. The holographic image is transparent to the driver within the vehicle, but retains its three dimensional appearance to viewers external to the vehicle. Advertising themes include corporate sponsors, general product advertising, and functional aspects such as denoting the number or status of a particular vehicle. While McAbee provides a novel use of holographic images for advertising, McAbee does not discuss advantageously linking advertising themes with racing cars and specific types of products to enhance their sale.

A method of advertising through enhanced gambling machines is discussed in U.S. Pat. No. 5,941,772B1 to Paige, wherein the variable slots of a slot machine are changed from numbers or traditional pictures to advertising logos or promoting products. The slot machine can also be modified to dispense promotional material or a system of coupons defining points redeemable for merchandise. Paige promotes products through their direct advertising or trademark type symbol and does tie the accumulation of points through the use of the machine with redeemable merchandise, but fails to develop a specific theme advantageously relating the nature of the product with a theme for advertising.

A continuing need exists for a method for selling jewelry that is related to the style of the jewelry and provides a theme which advantageously relates the style of jewelry with an advertising theme to a targeted group of consumers.

### SUMMARY

A method for selling jewelry is described including providing a collection of jewelry having a defined style and including means for ornamentation. An advertising theme is developed tying the style of the collection of jewelry with a geographically defined target population. Selecting a piece of jewelry from the means for ornamentation and tailoring the selected piece of jewelry.

The invention, together with attendant advantages, will be best understood by reference to the following detailed description of the invention when used in conjunction with the figures below.

### BRIEF DESCRIPTION OF THE DRAWINGS

The preferred embodiment of the presently disclosed method for selling jewelry is described herein with reference to the drawing, wherein:

FIG. 1 is a simplified schematic diagram of a first embodiment of a method for selling jewelry in accordance with the present disclosure.

### DETAILED DESCRIPTION OF THE EMBODIMENTS

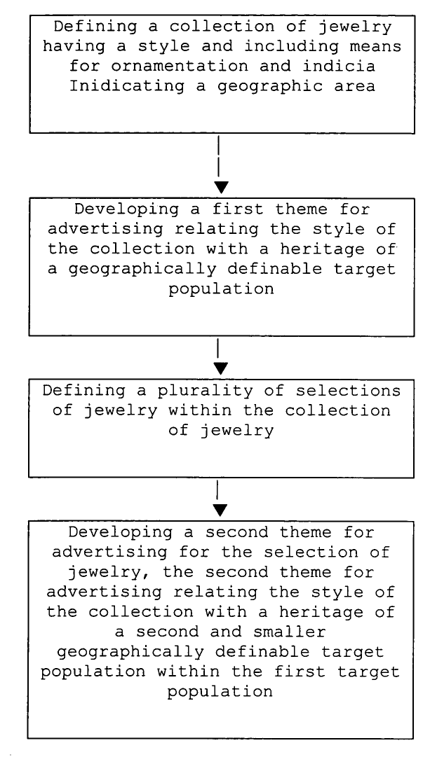

Referring now in specific detail to the drawings in which like referenced numerals identify similar or identical elements throughout FIG. 1, a novel method of selling a collection of jewelry 10 is shown including a collection of jewelry 20 having a style and a theme for advertising or theme 30 related to the style of collection of jewelry 20 that targets a defined group of individuals.

In one preferred embodiment, as shown in FIG. 1, collection of jewelry 20 includes a plurality of selections of jewelry 40 having specific types and styles of individual means for ornamentation 50 in consonance with the theme 30. Each selection of jewelry 40 has one or more means for ornamentation 50. Means for ornamentation 50 can include a broad range of types of jewelry pieces such as, but not limited to crosses, rings, earrings, bangles, necklaces, bracelets, chains, pins, jewelry boxes, cuff links, tie clasps/pins, collar pins, and bill clips.

The style of collection of jewelry 20 is preferably an art deco style, but can be any major category of jewelry styling. The most preferable art deco style has an antique ornate art deco appearance derived from styles in the 1920s. Platinum is the preferred material of fabrication, but any metal, metal alloy, or precious metal can be used to fabricate means for ornamentation 50.

Means for ornamentation 50 is configured for being tailored to suit the individual preferences of a buyer. The range of tailoring for a buyer can extend from purchasing an existing fabricated piece of jewelry without modification to fabricating a unique variation of an existing jewelry design to meet the preferences of a buyer. Within this range includes modifying the existing design to include mounting one or more different precious stones selected by the buyer into an existing setting of the jewelry piece. Accent stones can be similarly used for tailoring. The different types or styles of settings for stones can also be selectively modified for select pieces of jewelry. Tailoring individual jewelry pieces can include fabricating the selected means for ornamentation 50 from a different metal, metal alloy, or precious metal. In addition, selected pieces of jewelry can have combinations of two or more of the above materials of fabrication.

Theme for advertising 30 of the first preferred embodiment of traditional ornate art deco collection of jewelry 20 includes defining a grouping of jewelry into a collection having a defined style. Based on that collection's style, theme for advertising 30 is developed that is linked with the style of collection of jewelry 20 and a specific target population. In one example, in the present preferred embodiment of collection of jewelry 20 has the antique art deco style, a novel theme 30 includes relating the traditional appearance of the art deco style with an appeal to the heritage and roots of a desired target population in a definable geographic region. In this one preferred embodiment, the definable geographic region includes a State within the United States of America. The definable geographic region, however, can include a county, a locality, a city, or any other definable area of land within any nation.

In this one preferred embodiment theme of advertising 30 relates the concept of “Heritage” with the traditional art deco style of collection of jewelry 20. This theme of advertising 30 draws upon the relation of a target population, preferably defined as the population of a single State within the United States, with their traditional roots. The identity of target populations with their respective States is typically strong in the United States as well as in defined regions, such as the South or New England. Utilizing theme 30 based on geographical regions or entities, such as States, provides a broad base appeal to the given defined target population that is in consonance with the traditional art deco style, for example, and the types of jewelry in means for ornamentation 50 elected to be manufactured within that style.

Thus, by combining the defining elements of the term “Heritage”, a definable region, and the term “Collection” an advertising theme 30 for collection of jewelry 20 is defined providing a logical link between a target population, the style of collection of jewelry 20, and theme for advertising 30. The term “Heritage” in this example, provides a key element of identification with the relative stability of the population, place of birth, or at least a favorably remember place of living associated with that definable region in which generations have positive memories of and/or have maintained their ties to their “home” in specific localities.

This association in one preferred embodiment between the overarching term of “Collection” of collection of jewelry 20, theme of advertising 30 emphasizing “Heritage”, and the target population of a historically rich and traditional state such as Mississippi can be particularly advantageous when placed in consonance in one preferred application to define a “Mississippi Heritage Collection”, for example. The State of Mississippi has strong antebellum traditions and a historically oriented population that is directly relatable to the art deco style collection of jewelry 20.

This association with the target population with theme for advertising 30 can be further enhanced by naming lower tiered selections of jewelry 40 for a site within the given region. Thus, advertising theme 30 can be further enhanced by using a secondary theme for advertising 35 focusing on a site within the defined region, for example. Secondary theme for advertising 35 in one preferred embodiment names each selection of jewelry 40 in honor of sites that are cities within a State defined by advertising theme 30. Advertising theme 35 for selection of jewelry 40 can also be named for localities, counties, or other definable areas that are portions of a region. Alternatively, advertising theme 35 can be named other for man made features, natural geographic features, or historical locations. Other man made features could include items such as, but not limited to bridges, buildings, dams, and canals, for example. Natural features can be rivers, valleys, canyons, falls, mountains, and hills, for example. Secondary theme 35 identifies selection of jewelry 40 with a site that is a subset of the region defined by theme for advertising 30 that is readily identifiable with a similarly reduced subset of the target population defined by the region.

Thus, the method of selling a collection of jewelry 10 is enhanced in this one preferred embodiment by the combination of the antique ornate art deco style of collection of jewelry 20 with theme of advertising 30 targeting a defined population in a State and emphasizing the heritage of the population of that State. Theme for advertising 30 is further enhanced by the creation of selections of jewelry 40 having theme of advertising 35 in consonance with theme for advertising 30 by being associated cities within that state.

It is understood, that while, there is a clear intent for the primary target population to be that of the defined region and sites within that region, the appeal of these primary and secondary themes can exceed the boundaries of the defined region.

Means for ornamentation 50 within each selection of jewelry 40 and/or each collection of jewelry 20 can selectively include ornamental designs or indicia positioned on an outer surface or an inner surface of the piece. The indicia or designs can depict, for example, a map depicting an outline defining the region for collection of jewelry 20 and the location of the site in the region, for example, that forwards advertising theme 30. In one preferred embodiment, the indicia are positioned solely on the inner surfaces of the ring. Alternatively, the piece of jewelry can include a depiction of a portion of the city or geographical feature such as, but not limited to, a vertical, perspective, or skyline type depiction.

In operation, the method for selling a collection of jewelry 10 includes defining collection of jewelry 20 having a style and means for ornamentation 50. Means for ornamentation 50 defines the range of types of the pieces of jewelry. A theme for advertising 30 is developed tying the style and types of jewelry in the collection of jewelry 20 with a theme for advertising 30 configured for appeal to a defined geographic target population. The style of jewelry is preferably a traditional art deco type style that is in consonance with the appeal of advertising theme 30 to the heritage or traditions of the target population. A secondary theme 35 is developed further defining a reduced portion of the target population and relating that reduced target population to selections of jewelry 40 having styles and types of jewelry in consonance with collection of jewelry 20.

A buyer selects a means for ornamentation 50 from one or more of the collections of jewelry 20. Preferably, the collections are designated by the names of States or regions such as, for example, the “Mississippi Heritage Collection” to add distinction and additional attraction to the population of a specific geographic locality to the style of each collection. The overall style of collection of jewelry 20 can be specifically targeted for its appeal to a given State. The buyer then surveys means for ornamentation 50 for individual pieces or groupings of pieces within the one ore more collections of jewelry 20 and/or jewelry styles and coordinated themes for advertising 30. The buyer can elect from a range of tailoring of the selected piece of jewelry within means for ornamentation 50 from accepting the piece without modification to varying one or more aspects of the piece including the precious stone(s), accent stone(s), material of fabrication, and mounting. The buying process can also include sizing of the jewelry piece.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. All such changes and modifications are intended to be included within the scope of the disclosure.

1. A method for selling jewelry comprising the steps of:
providing a collection of jewelry having a defined style and including means for ornamentation;
developing a first advertising theme, the advertising theme tying the style of the collection of jewelry with a first geographically defined region;
developing a second advertising theme, the second advertising theme identifying means for ornamentation with a second and smaller geographically defined region within the first geographically defined region; and
selecting a piece of jewelry from the means for ornamentation and tailoring the selected piece of jewelry.

2. The method of claim 1, wherein the step of providing further includes a plurality of jewelry selections in each collection of jewelry, the second theme of advertising being developed for the plurality of selections of jewelry, each selection of jewelry having a style that defines a variation on the style of the jewelry collection, the second theme of advertising being variation on the theme of advertising of the jewelry collection.

3. The method of claim 1, wherein the step of providing includes indicia defining the theme of the collection of jewelry.

4. The method of claim 1, wherein the step of selecting includes selecting at least one precious stone for mounting in the selected piece of jewelry.

5. The method of claim 1, wherein the step of selecting includes selecting at least one accent stone for mounting in the selected piece of jewelry.

6. The method of claim 1, wherein the step of developing includes selecting a geographically defined entity and defining a theme of heritage for one collection of jewelry associated with the geographic entity.

7. The method of claim 1, wherein the step of developing a first advertising theme further includes relating the advertising theme to a State, the State being a State within the United States of America.

8. The method of claim 1, wherein the step of developing a first advertising theme further includes relating the heritage of the target population with the collection of jewelry.

9. The method of claim 2, wherein the step of developing a second advertising theme for the selection of jewelry further includes developing the secondary advertising theme to define the second geographically defined region as a site within in the first geographically defined region.

10. The method of claim 7, wherein the secondary advertising theme includes identifying the selection of jewelry in honor of at least one of a city, a man made feature, or a natural geographic feature within a State.

11. The method of claim 1, wherein the step of providing includes providing a collection of jewelry having an art deco style.

12. The method of claim 1, wherein the step of providing includes means for ornamentation primarily made from one or more precious metals.

13. The method of claim 1, wherein the step of providing includes means for ornamentation made at least partially of platinum.

14. A method for selling jewelry comprising the steps of:
providing at least one collection of jewelry having a style, the at least one collection of jewelry including means for ornamentation;
developing a first theme for advertising the collection of jewelry, the first advertising theme relating the style of the collection of jewelry with a first target population in a first geographically defined region;
a plurality of selections of jewelry being defined in each collection of jewelry;
developing a second theme for advertising for each selection of jewelry, the second theme for advertising being related to the first theme for advertising and being associated with a second smaller target population within the first target population, the second theme for advertising defining a site within the first geographically defined region; and
selecting means for ornamentation from a selection of jewelry and tailoring the selected means for ornamentation.

15. The method of claim 14, wherein the step of developing an advertising theme further includes relating the advertising theme to a heritage of a State, the State being a State within the United States of America.

16. The method of claim 15, wherein the site for the secondary advertising theme includes at least one of a city, a man made feature, or a natural geographic feature within the State.

17. The method of claim 14, wherein the step of providing includes providing the collection of jewelry having an art deco style.

18. A method for selling jewelry comprising the steps of:
providing at least one collection of jewelry having a style, the at least one collection of jewelry including means for ornamentation;
developing a first theme for advertising the collection of jewelry, the first advertising theme relating the style of the collection of jewelry with a heritage of a defined target population of a State in the United States of America;
a plurality of selections of jewelry being defined in each collection of jewelry;
developing a second theme for advertising for each selection of jewelry, the second theme for advertising being related to the first theme for advertising and being associated with a portion of the defined target population of a site in the State; and
selecting means for ornamentation from a selection of jewelry and tailoring the selected means for ornamentation.

19. The method of claim 18, wherein the site of the secondary advertising theme includes at least one of a city, a man made feature, or a natural geographic feature within the State.

20. The method of claim 18, wherein the step of providing includes providing a collection of jewelry having an art deco style.
